(19) United States
(12) Patent Application Publication
(10) Pub. No.: US 2009/0243370 A1
(43) Pub. Date: Oct. 1, 2009

(54) WHEEL WEIGHT

(75) Inventors: Roger Peniche, Franklin, TN (US); Guido Brandt, East Bentleigh (AU); Kevin Keefe, Brentwood, TN (US)

Correspondence Address: NELSON MULLINS RILEY & SCARBOROUGH, LLP, 1320 MAIN STREET, 17TH FLOOR, COLUMBIA, SC, 29201, US

(73) Assignee: HENNESSY INDUSTRIES, INC., LaVergne, TN (US)

(21) Appl. No.: 12/413,238

(22) Filed: Mar. 27, 2009

Related U.S. Application Data
(60) Provisional application No. 61/041,056, filed on Mar. 31, 2008.
(60) Provisional application No. 61/041,807, filed on Apr. 2, 2008.

(51) Int. Cl. B60B 15/28; B23P 11/00

(52) U.S. Cl. 301/5.21; 29/426.5

(57) ABSTRACT

A wheel weight segment for use on a wheel including a rim, having a body with a top surface, a bottom surface, a first side and a second side disposed opposite the first side. A top lip portion with a top surface extends outwardly from the first side of the body and a bottom lip portion with a bottom surface extends outwardly from the second side of the body. The top surface of the body and the top surface of the top lip portion lie in a first plane, and the bottom surface of the body and the bottom surface of the bottom lip portion lie in a second plane.

### CLAIM OF PRIORITY

This application claims priority to U.S. Provisional Patent Application Ser. Nos. 61/041,056 filed Mar. 31, 2008, and 61/041,807 filed Apr. 2, 2008, the entire disclosures of which are hereby incorporated by reference.

### FIELD OF THE INVENTION

The present invention generally relates to wheel weights. More particularly, the invention relates to adhesive wheel weights placed on the rim of a wheel.

### BACKGROUND OF THE INVENTION

In order to reduce excessive vibration, vehicle wheels are often balanced by placing weights at selected locations. The weights typically include a mass portion which is attached to a rim of the wheel using a spring clip or a suitable adhesive. Due to high mass and low cost, such weights have been made of lead. Because of various factors, however, it is becoming desirable to manufacture such weights of materials other than lead. The shape of the traditional adhesive weights may not be advantageous for placing the weight on a curved surface, such as the inner periphery of the wheel's rim.

Additionally, adhesive weights typically have a tape liner attached to an adhesive tape on a bottom surface area of the weight. In order to apply the weight to the wheel's rim, the tape liner must first be removed by the user. In some circumstances, it can be difficult for the user of the adhesive weight to remove the tape liner from the tape. Also, the tape liner may be inadvertently removed from too many weight segments, thus creating adhesive weight segments that are wasted.

The adhesive weights are typically produced in strips containing 12 or 24 weight segments. In some instances, strips of wheel weights are produced as a roll. Once it is determined how many weight segments are needed for a particular application, an equivalent number of weight segments are removed from the strip of wheel weight segments. In some cases, a tool is needed to separate the desired number of weight segments from the roll. This step adds time and expense to the wheel weight application process.

Thus there is a need for wheel weight with a design that allows for easier application by the user. The present invention recognizes and addresses the foregoing considerations, and others, of prior art construction and methods.

### SUMMARY OF THE INVENTION

The present invention provides a variety of configurations for vehicle wheel weights. Preferred embodiments may utilize iron or low carbon steel for mass instead of lead, as has generally been used in the past. As understood by those skilled in the art, any suitable material may be used.

One embodiment of the present invention provides a wheel weight for use with a wheel including a rim having a first wheel weight segment including a top surface, a bottom surface, a top lip portion and a bottom lip portion, the top lip portion and the bottom lip portion extending outwardly from opposing sides of the first wheel weight segment, and a second wheel weight segment including a top surface, a bottom surface, a top lip portion and a bottom lip portion, the top lip portion and the bottom lip portion extending outwardly from opposing sides of the second wheel weight segment. The top lip portion of the first wheel weight segment overlaps the bottom lip portion of the second wheel weight segment when the first wheel weight segment is positioned adjacent the second wheel weight segment.

Another embodiment of the present invention provides a wheel weight segment for use on a wheel including a rim having a body with a top surface, a bottom surface, a first side and a second side disposed opposite the first side, a top lip portion with a top surface, the top lip portion extending outwardly from the first side of the body, and a bottom lip portion with a bottom surface, the bottom lip portion extending outwardly from the second side of the body. The top surface of the body and the top surface of the top lip portion lie in a first plane, and the bottom surface of the body and the bottom surface of the bottom lip portion lie in a second plane.

Another embodiment of the present invention provides a wheel weight segment for use on a wheel including a rim having a body with a top surface, a bottom surface, a first side and a second side disposed opposite the first side, the first side and the second side extending between the top surface and the bottom surface, an adhesive tape including an adhesive top surface and an adhesive bottom surface, the bottom surface of the body of the wheel weight segment being secured to the adhesive top surface of the adhesive tape, and a tape liner releasably secured to the adhesive bottom surface of the adhesive tape. The tape liner includes a tab that is formed by cutting through the tape liner such that the tab can be separated from the adhesive bottom surface of the adhesive tape while the remainder of the tape liner remains releasably secured to the adhesive tape.

A final embodiment of the present invention provides a method of removing a wheel weight from a rim of a wheel with a tool, including the steps of providing a first wheel weight segment having a top surface, a bottom surface, a top lip portion and a bottom lip portion, the top lip portion and the bottom lip portion extending outwardly from opposing sides of the first wheel weight segment, the first wheel weight segment being adhesively secured to the rim such that the top lip portion of the first wheel weight segment forms a recess with the rim, and a second wheel weight segment including a top surface, a bottom surface, a top lip portion and a bottom lip portion, the top lip portion and the bottom lip portion extending outwardly from opposing sides of the second wheel weight segment, the second wheel weight segment being adhesively secured to the rim such that the top lip portion of the second wheel weight segment overlapping the bottom lip portion of the first wheel weight segment, placing a first portion of the tool in the recess formed by the top lip portion of the first wheel weight segment and the rim, and applying force on a second portion of the tool such that the second end of the tool pivots away from the rim and applies a lifting force on the top lip portion of the first wheel weight segment.

In accordance with embodiments discussed herein, the various configurations of the wheel weights allow the wheel weights to be attached to a curved surface of a vehicle wheel rim. The adhesive wheel weight segments making up the wheel weight preferably have an upper protruding lip on one end and a lower protruding lip on the other end. When aligned in a strip of weight segments, the lower protruding lip creates a cutout which receives the upper lip of the adjacent weight segment in an interlocking fashion.

In accordance with other embodiments of the present invention, the wheel weight may have a removable tape liner adhered to adhesive tape on the bottom surface of the wheel weight segments. In order to aid in the removal of the tape liner from the wheel weight, the tape liner preferably contains a series of serrations or perforations that form lift tabs. The tabs can be gripped by the user when removing the tape liner from the wheel weight prior to application to the vehicle's wheel. Also, in some embodiments, the tape liner has additional serrations or perforations to aid in the separation of individual weight segments from the remainder with the wheel weight. The serrations or perforations may be transverse to the longitudinal axis of the strip of wheel weights. In some embodiments, the serrations or perforations may be aligned with the joint between adjacent wheel weight segments, thus allowing adjacent weight segments to be easily separated, preferably without the use of a separate tool.

In other embodiments, the strip wheel weight segments may also include a strip of tape located on the top surface opposite to the bottom surface containing the adhesive tape. This additional strip of tape makes the strip of wheel weight segments more rigid and, therefore, easier to install. Other objects, features and aspects of the present invention are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1A is a perspective view of a vehicle wheel weight segment constructed in accordance with an embodiment of the present invention;

FIG. 1B is a perspective view of a vehicle wheel weight segment constructed in accordance with an embodiment of the present invention;

FIG. 1C is a perspective view of a vehicle wheel weight segment constructed in accordance with an embodiment of the present invention;

FIG. 1D is a perspective view of a vehicle wheel weight segment constructed in accordance with an embodiment of the present invention;

FIG. 1E is a perspective view of a vehicle wheel weight segment constructed in accordance with an embodiment of the present invention;

FIG. 2 is a side elevational view of a vehicle wheel weight segment constructed in accordance with the present invention;

FIG. 3 is a side elevational view, similar to FIG. 2, showing a series of vehicle wheel weight segments arranged in a strip;

FIG. 4 is a perspective view of a series of vehicle wheel weight segments arranged in a strip;

FIG. 5 shows a series of vehicle wheel weight segments located on a double-sided tape which has been flexed;

FIG. 6 is a side elevational view of vehicle wheel weight segments in accordance with the present invention, attached to a surface of a wheel;

FIG. 7A is a top view of a tape liner in accordance with the present invention;

FIG. 7B is a perspective view of a strip of wheel weight segments including a tape liner in accordance with the present invention, further showing removal thereof;

FIG. 8 is a perspective view of a series of vehicle wheel weight segments arranged in a strip;

FIG. 9 is a perspective view of a series of vehicle wheel weight segments arranged in a strip with a top tape in accordance with the present invention; and

FIG. 10 is a perspective view of a series of vehicle wheel weight segments, such as those shown in FIG. 9, without a top tape, as shown in FIG. 9.

Repeat use of reference characters in the present specification and drawings is intended to represent same or analogous features or elements of the invention.

### DETAILED DESCRIPTION

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

FIGS. 1A through 1E illustrate a vehicle wheel weight segment 10 constructed in accordance with a first embodiment of the present invention. As shown, wheel weight segment 10 preferably includes a top lip portion 12 and a bottom lip portion 14. In preferred embodiments, the lip portions extend across the entire width of the wheel weight segment, although this is not necessary. For example, the lip portions need not extend across the entire width so long as they extend outwardly from wheel weight segment 10 opposite one another, as discussed in greater detail below. Wheel weight segment 10 may be any desired mass, such as 0.5 oz., 0.25 oz., etc. In some embodiments, the mass of the wheel weight segment may be indicated on the wheel weight segment, as shown in FIGS. 1B, 1C and 1E. The width of wheel weight segment 10 may vary as well. For instance, for wheel weight segments with a lower side profile, the width of wheel weight segment 10 may be increased to maintain the weight of the segment although the height of the segment has been decreased. An example of a low profile wheel weight segment 10 is shown in FIG. 1D. Such configurations may be used when a wheel weight segment with a reduced height is desirable, such as for aesthetic reasons. As shown in FIGS. 1A through 1E, the overall width, weight and length of each wheel weight segment 10 is variable. Preferably, top lip portion 12 is of the same depth as bottom lip portion 14. In some embodiments, however, these depths may differ.

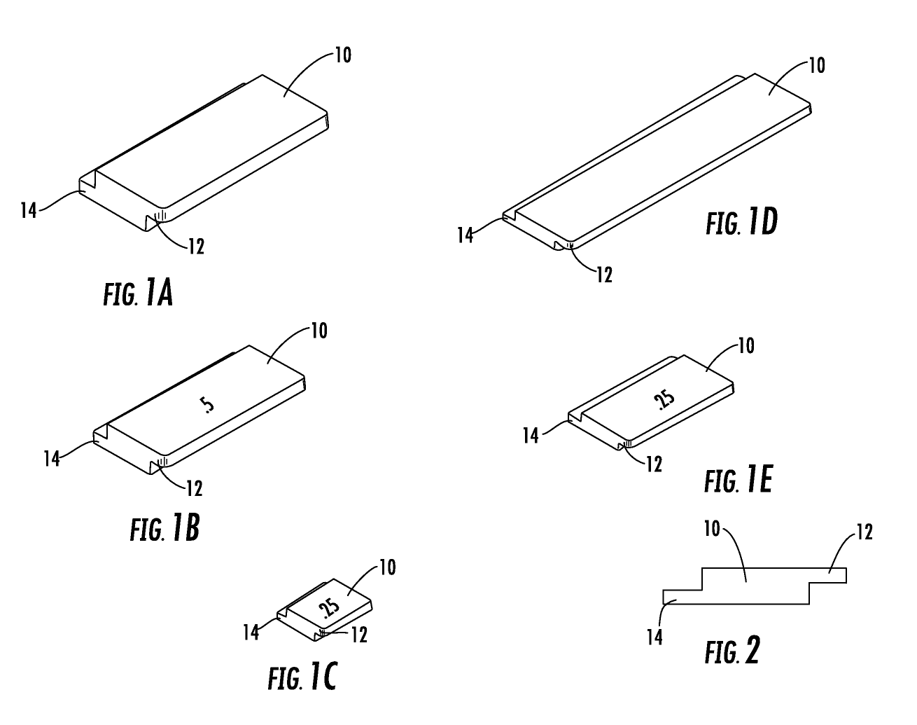

As shown in a side elevation of wheel weight segment 10, illustrated by FIG. 2, top lip portion 12 and bottom lip portion 14 extend outward, respectively, thus creating a somewhat “Z-shaped” profile.

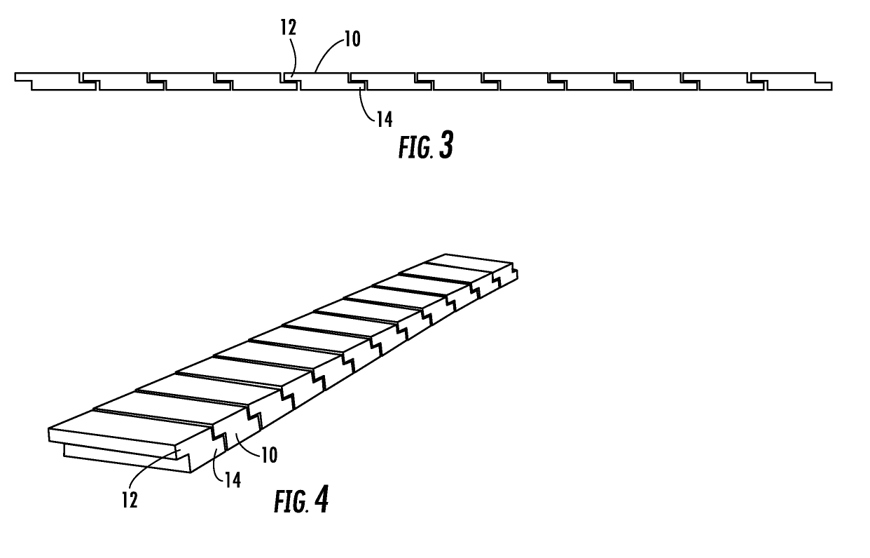

Adhesive wheel weights are traditionally assembled in strips or rolls of multiple wheel weights segments 10. In some instances, 12 or 24 wheel weight segments are affixed in a strip. The user then severs, or otherwise breaks off, the necessary amount of wheel weight segments from the strip and attaches them to a wheel. When arranged sequentially in a strip, top lip portion 12 and bottom lip portion 14 allow adjacent wheel weight segments 10 to overlap. As shown in FIGS. 3 and 4, top lip portion 12 preferably sits on top of bottom lip portion 14 of the adjacent wheel weight segment 10.

As shown in FIG. 5, an adhesive tape 18 may be mounted onto a surface of wheel weight segments 10 (the bottom surface). Adhesive tape 18 preferably is double-sided and therefore has adhesive on both top and bottom surfaces. In the preferred embodiment, adhesive tape 18 extends across multiple wheel weights segments 10. In other embodiments, glue or other adequate adhesive may be applied to the bottom side of wheel weight segments 10. A tape liner 20 is preferably adhered to the surface of adhesive tape 18 opposite wheel weight segments 10. Tape liner 20 is removed by the user in order to expose adhesive tape 18 so that it can be mounted onto a desired object, such as a vehicle wheel rim.

The interlocking wheel weight segments 10 allow for the strip of wheel weight segments 10 to be curved to fit a variety of different curved surfaces of a wheel rim. As illustrated in FIG. 5, a strip of wheel weight segments 10 is flexible to follow the contour of the wheel rim. Such flexibility aids the user when installing the strip of wheel weight segments 10 onto the rim of the wheel. The interlocking nature of top lip portion 12 and bottom lip portion 14 also aids in keeping the wheel weight segments 10 affixed to the rim of the wheel during typical high speed rotation of an automobile wheel.

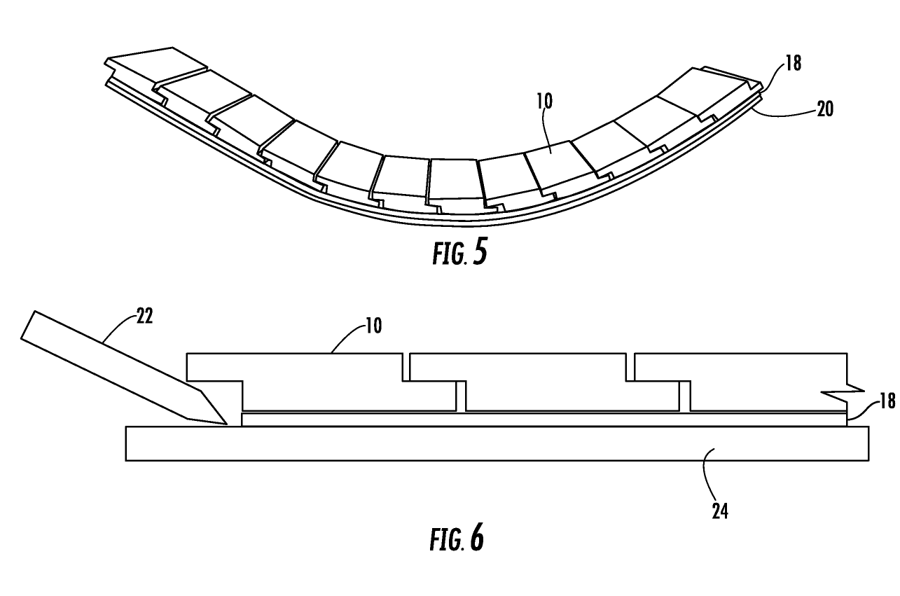

FIG. 6 illustrates a preferred process for removing multiple wheel weight segments 10 from a surface such as wheel rim 24 (Although wheel rim 24 is shown to be straight I this example, one skilled in the art will appreciate that wheel rim 24 will actually be cured). As shown, when mounted on rim 24 of the wheel, top lip portion 12 creates a cavity between the lip and wheel rim 24. A tool 22 may be placed in the cavity in order to apply prying force to top lip portion 12. Tool 22 may be a screwdriver, or any other tool capable of performing a prying function. When enough force is applied, the adhesive force from adhesive tape 18 may be overcome and allow wheel weight segments 10 to be separated from wheel rim 24. Furthermore, due to the interlocking nature of the wheel weight segments, the “leading” wheel weight segment 10 that is pried from wheel rim 24 with tool 22 will pull the “trailing” wheel weight segments 10 from wheel rim 24 as well. Specifically, as the first wheel weight segment 10, or leading segment, is pried from wheel rim 24, the bottom lip portion 14 of that wheel weight segment 10 will apply force to top lip portion 12 of the adjacent wheel weight segment 10 in the strip, lifting it off wheel rim 24. Thus, removing an entire strip of interlocking wheel weight segments 10 in accordance with the present invention is different than removing a strip of typical wheel weight segments that are not interlocked, where each wheel weight segment has to be pried off the wheel rim independently.

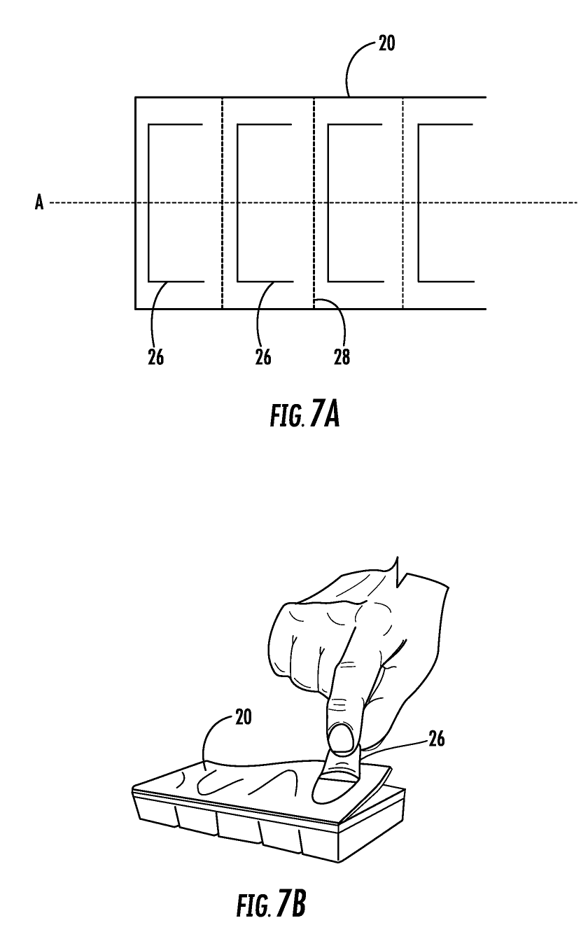

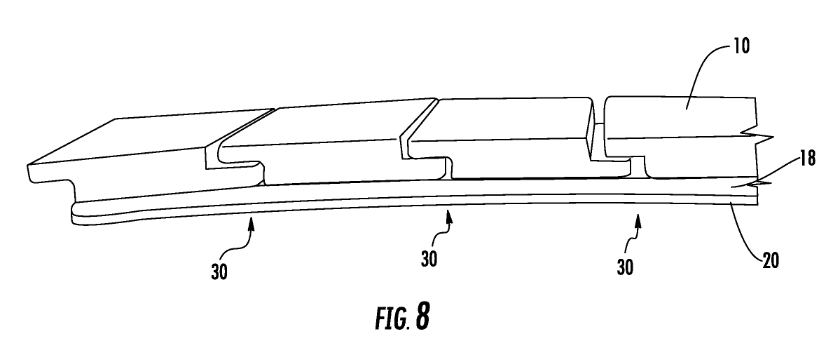

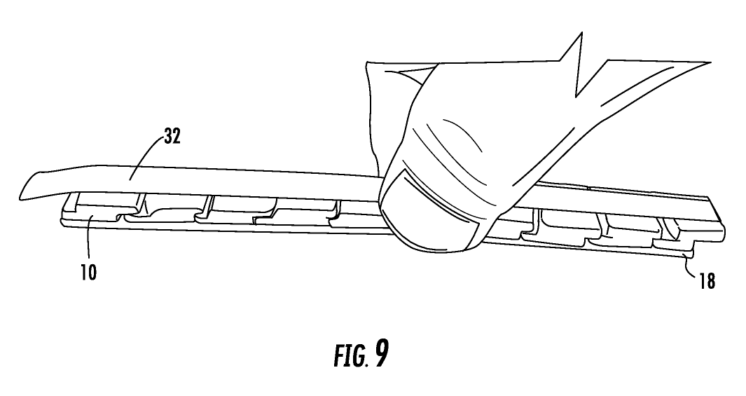

Preferred embodiments of tape liner 20 are further illustrated in FIGS. 7A and 7B. As shown, tape liner 20 contains tabs 26 which are preferably cut into the liner. Tabs 26 are preferably flush with tape liner 20, but may be lifted off of adhesive tape 18 by the user during the installation process. Once a tab 26 is lifted from tape liner 20, the user may continue to pull tab 26 to remove the rest of the liner from the wheel weight segments 10. For instance, if the user would like to install four wheel weight segments 10 onto a vehicle wheel, the user would only have to pull up on a tab 26 to remove the liner from all four wheel weight segments.

As shown, tabs 26 may correspond to each individual wheel weight segment 10. In some embodiments, there can be a higher than one to one ratio of wheel weight segments 10 to tabs. Conversely, in other embodiments, there can be a higher than one to one ratio of tabs to wheel weight segments. In some embodiments, tab 26 may be generally “C-shaped”, as shown in FIGS. 7A and 7B. In other embodiments, tab 26 may form an arch, a triangle, or any other acceptable shape. Further, tab 26 may be arranged to hinge transverse to the longitudinal axis A, or any other suitable configuration, such as parallel to longitudinal axis A (FIG. 7B), or oblique to longitudinal axis A (not shown).

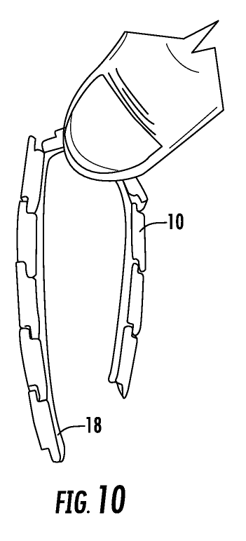

In some embodiments, tape liner 20 and adhesive tape 18 also include perforations 28 (FIG. 7A) extending across tape liner 20 transverse to longitudinal axis A. Perforations 28 are preferably located at each joint 30 (FIG. 8) of adjacent wheel weight segments 10. Perforations 28 allow the user to separate the desired number of wheel weight segments 10 from a larger strip of wheel weight segments 10. Preferably, this separation may be preformed without the use of additional tools. In some embodiments, perforations 28 may be an extended dash or a series of dashes (as shown in FIG. 7A) cut through tape liner 20. In other embodiments, perforations 28 may be a series of holes, or a combination of holes and dashes. Perforations 28 may only be cut into tape liner 20, but are preferably also cut into adhesive tape 18 as well. Accordingly, separation of adhesive tape 18 near the joints 30 of adjacent weight segments is facilitated.

As illustrated in FIG. 9, some embodiments may utilize a top tape 32. Top tape 32 is preferably an elongated strip of tape that has adhesive on one side. The adhesive side is preferably attached to the top surfaces of wheel weight segments 10. Once attached, top tape 32 keeps adjacent wheel weights 10 in a semi-rigid state so that they are easier to install. As shown in FIG. 10, without the use of top tape 32, adjacent wheel weight segments 10 may have the tendency to hinge about adhesive tape 18. By using top tape 32, adjacent wheel weight segments 10 maintain a certain amount of rigidity so that they can be curved to match the inner periphery of the wheel rim. Top tape 32 may be removed from wheel weight segments 10 after application, or it can be left adhered to wheel weight segments 10.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

What is claimed:

1. A wheel weight for use with a wheel including a rim, comprising:
a first wheel weight segment including a top surface, a bottom surface, a top lip portion and a bottom lip portion, the top lip portion and the bottom lip portion extending outwardly from opposing sides of the first wheel weight segment; and
a second wheel weight segment including a top surface, a bottom surface, a top lip portion and a bottom lip portion, the top lip portion and the bottom lip portion extending outwardly from opposing sides of the second wheel weight segment,
wherein the top lip portion of the first wheel weight segment overlaps the bottom lip portion of the second wheel weight segment when the first wheel weight segment is positioned adjacent the second wheel weight segment.

2. The wheel weight of claim 1, further comprising an adhesive tape including an adhesive top surface, wherein the bottom surfaces of the first wheel weight segment and the second wheel weight segment are both secured to the adhesive top surface of the adhesive tape.

3. The wheel weight of claim 2, wherein the adhesive tape further comprises an adhesive bottom surface that is adapted to be secured to the rim of the wheel.

4. The wheel weight of claim 3, further comprising a tape liner releasably secured to the adhesive bottom surface of the adhesive tape.

5. The wheel weight of claim 4, wherein the tape liner further comprises a tab that is formed by cutting through the tape liner such that the tab can be separated from the adhesive bottom surface of the adhesive tape while the remainder of the tape liner remains releasably secured to the adhesive tape.

6. The wheel weight of claim 5, further comprising a first tab formed opposite the bottom surface of the first wheel weight segment and a second tab formed opposite the bottom surface of the second wheel weight segment.

7. The wheel weight of claim 4, further comprising a series of perforations formed along a line extending transverse to a longitudinal center axis and extending through both the adhesive tape and the adhesive tape liner.

8. The wheel weight of claim 7, wherein the series of perforations is formed in portions of the adhesive tape and the tape liner that is disposed between the bottom surfaces of the first wheel weight segment and the second wheel weight segment.

9. The wheel weight of claim 2, further comprising a top tape including an adhesive bottom surface, wherein the adhesive bottom surface of the top tape is releasably secured to the top surfaces of both the first wheel weight segment and the second wheel weight segment.

10. The wheel weight of claim 2, wherein a cross-sectional profile of both the first wheel weight segment and the second wheel weight segment along a longitudinal center axis is Z-shaped.

11. The wheel weight of claim 1, wherein a weight value of the first wheel weight segment is disposed on the top surface of at least said first wheel weight segment.

12. A wheel weight segment for use on a wheel including a rim, comprising:
a body having a top surface, a bottom surface, a first side and a second side disposed opposite the first side;
a top lip portion with a top surface, the top lip portion extending outwardly from the first side of the body; and
a bottom lip portion with a bottom surface, the bottom lip portion extending outwardly from the second side of the body,
wherein the top surface of the body and the top surface of the top lip portion lie in a first plane, and the bottom surface of the body and the bottom surface of the bottom lip portion lie in a second plane.

13. The wheel weight segment of claim 12, wherein a height of the top lip portion and a height of the bottom lip portion are each less than a height of the body of the wheel weight segment.

14. The wheel weight segment of claim 12, wherein a weight value of the wheel weight segment is disposed on its top surface.

15. The wheel weight segment of claim 12, further comprising an adhesive tape including an adhesive top surface, wherein the bottom surfaces of the body of the wheel weight segment and the bottom lip portion are both secured to the adhesive top surface of the adhesive tape.

16. The wheel weight segment of claim 15, wherein the adhesive tape further comprises an adhesive bottom surface that is adapted to be secured to the rim of the wheel.

17. The wheel weight segment of claim 16, further comprising a top tape including an adhesive bottom surface, wherein the adhesive bottom surface of the top tape is releasably secured to the top surfaces of both the body of the wheel weight segment and the top lip portion.

18. The wheel weight segment of claim 16, further comprising a tape liner releasably secured to the adhesive bottom surface of the adhesive tape.

19. The wheel weight segment of claim 18, wherein the tape liner further comprises a tab that is formed by cutting through the tape liner such that the tab can be separated from the adhesive bottom surface of the adhesive tape while the remainder of the tape liner remains releasably secured to the adhesive tape.

20. A wheel weight segment for use on a wheel including a rim, comprising:
a body having a top surface, a bottom surface, a first side and a second side disposed opposite the first side, the first side and the second side extending between the top surface and the bottom surface;
an adhesive tape including an adhesive top surface and an adhesive bottom surface, the bottom surface of the body of the wheel weight segment being secured to the adhesive top surface of the adhesive tape; and
a tape liner releasably secured to the adhesive bottom surface of the adhesive tape,
wherein the tape liner includes a tab that is formed by cutting through the tape liner such that the tab can be separated from the adhesive bottom surface of the adhesive tape while the remainder of the tape liner remains releasably secured to the adhesive tape.

21. The wheel weight segment of claim 20, wherein the tab lies within an outer periphery of the tape liner.

22. The wheel weight segment of claim 20, wherein the tab is symmetric about a longitudinal center axis of the wheel weight segment, the first side and the second side of the body being transverse to the longitudinal center axis.

23. The wheel weight segment of claim 20, further comprising:
a top lip portion with a top surface, the top lip portion extending outwardly from the first side of the body; and
a bottom lip portion with a bottom surface, the bottom lip portion extending outwardly from the second side of the body,
wherein the top surface of the body and the top surface of the top lip portion lie in a first plane, and the bottom surface of the body and the bottom surface of the bottom lip portion lie in a second plane.

24. The wheel weight segment of claim 20, wherein the tab is C-shaped.

25. A method of removing a wheel weight from a rim of a wheel with a tool, comprising the steps of:
providing a first wheel weight segment including a top surface, a bottom surface, a top lip portion and a bottom lip portion, the top lip portion and the bottom lip portion extending outwardly from opposing sides of the first wheel weight segment, the first wheel weight segment being adhesively secured to the rim such that the top lip portion of the first wheel weight segment forms a recess with the rim;
providing a second wheel weight segment including a top surface, a bottom surface, a top lip portion and a bottom lip portion, the top lip portion and the bottom lip portion extending outwardly from opposing sides of the second wheel weight segment, the second wheel weight segment being adhesively secured to the rim such that,
the top lip portion of the second wheel weight segment overlapping the bottom lip portion of the first wheel weight segment,
placing a first portion of the tool in the recess formed by the top lip portion of the first wheel weight segment and the rim; and
applying force on a second portion of the tool such that the second portion of the tool pivots away from the rim and applies a lifting force on the top lip portion of the first wheel weight segment.

26. The method of claim 25, wherein the step of applying force continues until the first wheel weight segment is removed from the rim.

27. The method of claim 25, wherein the step of applying force continues until the bottom lip portion of the first wheel weight segment applies a lifting force on the top lip portion of the second wheel weight segment.

28. The method of claim 27, wherein the step of applying force continues until the first wheel weight segment and the second wheel weight segment are removed from the rim.
